(19) United States
(12) Patent Application Publication
(10) Pub. No.: US 2010/0118705 A1
(43) Pub. Date: May 13, 2010

(54) METHOD FOR SEAMLESS TRANSFER OF A MOBILE STATION TO A NEIGHBORING BASE STATION IN AN OVERLOAD CONDITION

(75) Inventors: Vikas Mehrotra, Addison, IL (US); Rishi R. Arora, Chicago, IL (US); Yun Jing, Rolling Meadows, IL (US); Apurv Mathur, Wheeling, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/266,667

(22) Filed: Nov. 7, 2008

(51) Int. Cl. H04J 3/14

(52) U.S. Cl. 370/237

(57) ABSTRACT

A method includes receiving a request from a mobile station (102) to initiate a call session with a base station (104). After receiving the request, the base station determines that it cannot process the call session with the mobile station because the base station is fully loaded and sends a busy indication to the mobile station in response to determining that it cannot process the call session. The method can also include sending a scan response to the mobile station indicating a load for a neighboring base station (106) to the base station and handing over the mobile station to the neighboring base station.

### FIELD OF THE INVENTION

The present invention relates generally to the transfer or handover of a mobile station in a wireless communication network, and in particular, to the seamless transfer of a mobile station to a neighboring base station when the attempted base station is in an overload condition.

### BACKGROUND

In wireless communication networks, a base station provides radio access to the network for a given geographical area. A mobile station gains access to the communication network by connecting to the base station. As the mobile station is mobile and moves within the network, the mobile station can connect to different base station. Base stations transfer control of the communications with the mobile stations between the different base stations using known handover processes. Handover provides a smooth process for a base station to transfer control to another base station under given circumstances such as when a mobile station is no longer in operating in the base station's cell.

Handover can be used to transfer control in other situations as well. As is known, control of a mobile station may be required when a base station is overloaded or at full capacity. Base stations do not necessarily allow a mobile station to remain connected and camp out on the base station when it is in full capacity or in an overload situation. In this situation, the base station does not have the available resources to provide communications for a mobile station that is attempting to connect with the overloaded base station. It is appropriate for the overloaded base station to then handover the mobile station to a neighboring base station that has the capacity to communicate with the mobile station. This type of handover may be necessary during network entry and when a new flow creation is required by a mobile station. These handovers can be initiated based on the signal strength measurements of the neighboring base stations.

While handover procedures are known, there is a need to initiate the handover process efficiently in the overload conditions so that a mobile station does not need to intiate a new wireless session with another base station. What is needed is a mechanism to notify the base station and mobile station of the overload condition so that a handover to a neighboring base station can be initiated.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example a wireless communication network including given network elements in accordance with some embodiments of the invention.

FIG. 2 is a call flow diagram showing transferring of a mobile station from a base station in an overload condition to a neighboring base station in accordance with some embodiments of the invention.

FIG. 3 is a call flow diagram showing transferring of a mobile station from a base station in an overload condition to a neighboring base station in accordance with some other embodiments of the invention.

FIG. 4 is a call flow diagram showing transferring of a mobile station from a base station in an overload condition to a neighboring base station in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to provide a seamless transfer of a mobile station from a base station in an overload condition to a neighboring base station. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of seamlessly transferring a mobile station from an overloaded base station to a neighboring base station as described herein. The non-processor circuits may include, but are not limited to, a radio receiver, a radio transmitter, signal drivers, clock circuits, power source circuits, and user input devices. As such, these functions may be interpreted as steps of a method to perform a seamless transfer of a mobile station from a base station in an overload condition to a neighboring base station. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In an embodiment, a method includes receiving a request from a mobile station to initiate a call session with a base station. After receiving the request, the base station determines that it cannot process the call session with the mobile station because the base station is fully loaded and sends a busy indication to the mobile station in response to determining that it cannot process the call session. The method also includes receiving a scanning request from the mobile station. The request can be one of a request for network entry, a request for new flow creation and a ranging request after an idle mode exit. The method can also include sending a scan response to the mobile station indicating a load for a neighboring base station to the base station and handing over the mobile station to the neighboring base station.

In another embodiment, a method is disclosed that includes sending a request from a mobile station to initiate a call session with a base station. When the mobile station receives a busy indication from the base station indicating that the base station cannot participate in the call session, the method includes sending scan request in response to the busy indication requesting that the base station provide data regarding neighboring base stations. In addition, the method can include sending a handover request requesting a handover to one of the neighboring base stations.

In addition, an embodiment is described for a wireless communication system that includes a mobile station and a base station. The base station receives a request from the mobile station to initiate a call session with the base station. In addition, the base station determines that the base station cannot process the call session and sends the mobile station a busy indication. The mobile station can respond to the busy indication by sending a scan request to the base station.

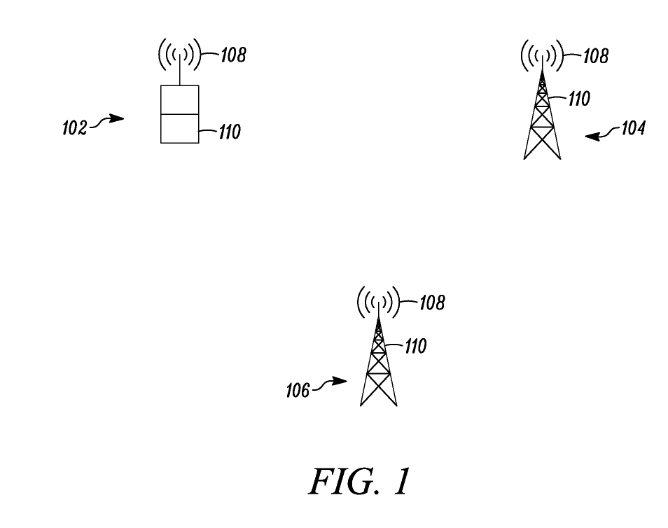

Turning to FIG. 1, a wireless communication network 100 is shown that can be one of the various known types of networks such as those utilizing IEEE 802.16. Wireless communication network 100 includes a mobile station 102 that attempts to connect to a base station 104. In addition to base station 104, wireless communication network includes at least one neighboring base station 106. In an embodiment, base station 104 and neighboring base station 106 can both provide services to the mobile station. It is understood, however, that mobile station 102 may have an initial preference to start a communication session with base station 104 because the signal strength from base station 104 is stronger than the signal strength of base station 106 or for other factors.

As is understood, the user equipment 102 and the base stations 104 and 106 both include at least a standard transceiver 108 and processor 110. The transceiver 108 transmits and receives messages and requests sent between the user equipment 102 and the base stations 104 and 106. The user equipment 102 and base stations 104 and 106 including their respective transceivers 110 are operated according to the operation of the processor 110.

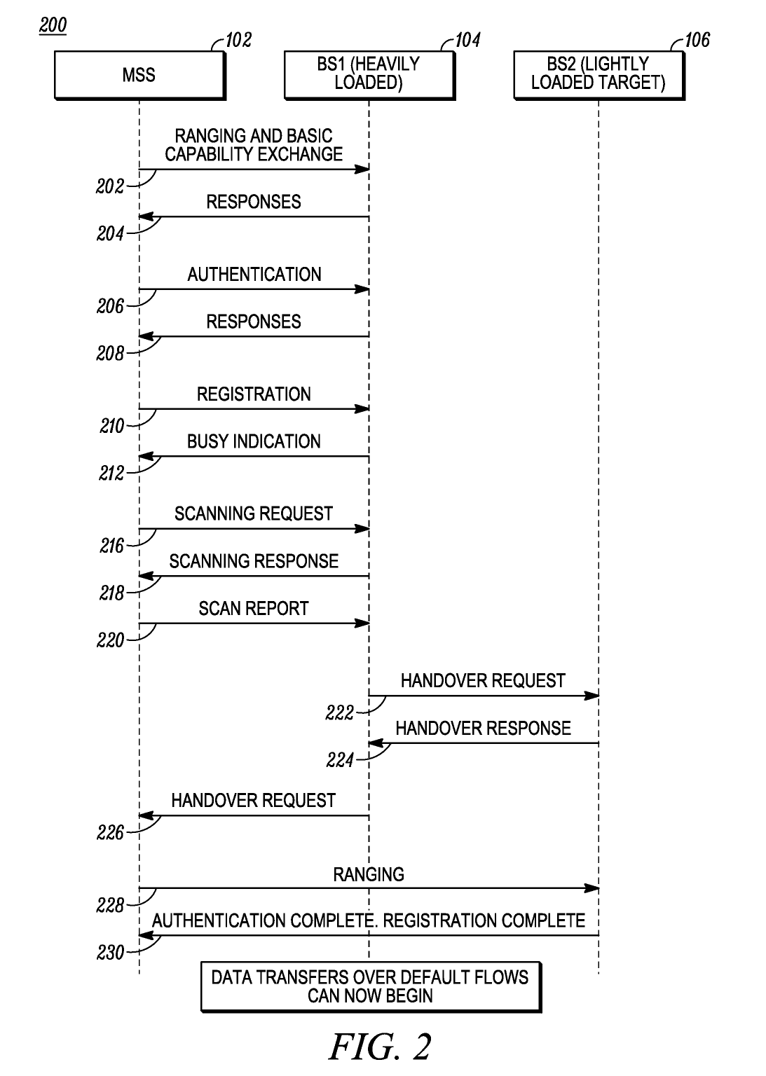

FIG. 2 shows a call flow diagram 200 that permits seamless transfer of a mobile station 102 from an initial base station 104 that is in overloaded or full capacity condition to a neighboring base station 106 during network entry. In network entry, the mobile station 102 is establishing a connection with a base station. Network entry can occur during power up of the mobile station 102. As seen in FIG. 2, the disclosed seamless transfer begins when the mobile station initiates network entry by sending 202 ranging and basic capability exchange messages with the initial base station 104. The base station 104 sends 204 the necessary responses to the ranging requests. In the next step of network initiation, the mobile station 102 sends 206 authentication messages to the initial base station 104, and the base station transmits 208 the necessary responses for authentication. After authentication, the mobile station 102 attempts to register with the base station 104 and sends 210 registration request messages to the initial base station 104.

Upon receipt of the registration request messages, the initial base station 104 determines that it is in overload condition or that it is fully loaded. If the base station rejects the service flow due to the absence of sufficient resource to admit the service flow, such as determining to reject the registration request message, the initial base station 104 initiates procedures to move the mobile station to a different base station such as neighboring base station 106. Accordingly and since the initial base station 104 is in overload condition, it responds 212 to the mobile station with a busy indication that informs the mobile station 102 of the base station's condition and that the base station cannot register the mobile station. Based on the busy indication message, the mobile station knows that the registration with initial base station 104 has failed and sends 214 the initial base station 103 a scanning request message. The scanning request message requests that the initial base station provide information regarding the neighboring base stations with which the mobile station can connect to since the initial base station is overloaded. A scan response is sent 214 by the initial base station with this data.

Based on the scan report, the mobile station selects a neighboring base station 106 from among the available base stations provided in the scan report and sends 216 a scan report choosing the neighboring base station 106 to the initial base station 104. With the information regarding the neighboring base station 106, the initial base station 104 sends 218 an handover request to neighboring base station 106, which responds 220 to the initial base station 104 with a handover response. The initial base station 104 then sends 222 data to the mobile station in a handover request message. The mobile station uses the data regarding the neighboring base station 106 to send 224 ranging information to the neighboring base station. The neighboring base station responds 226 with authentication and registration data. Data transfers between the mobile station 102 and the neighboring base station 106 can begin.

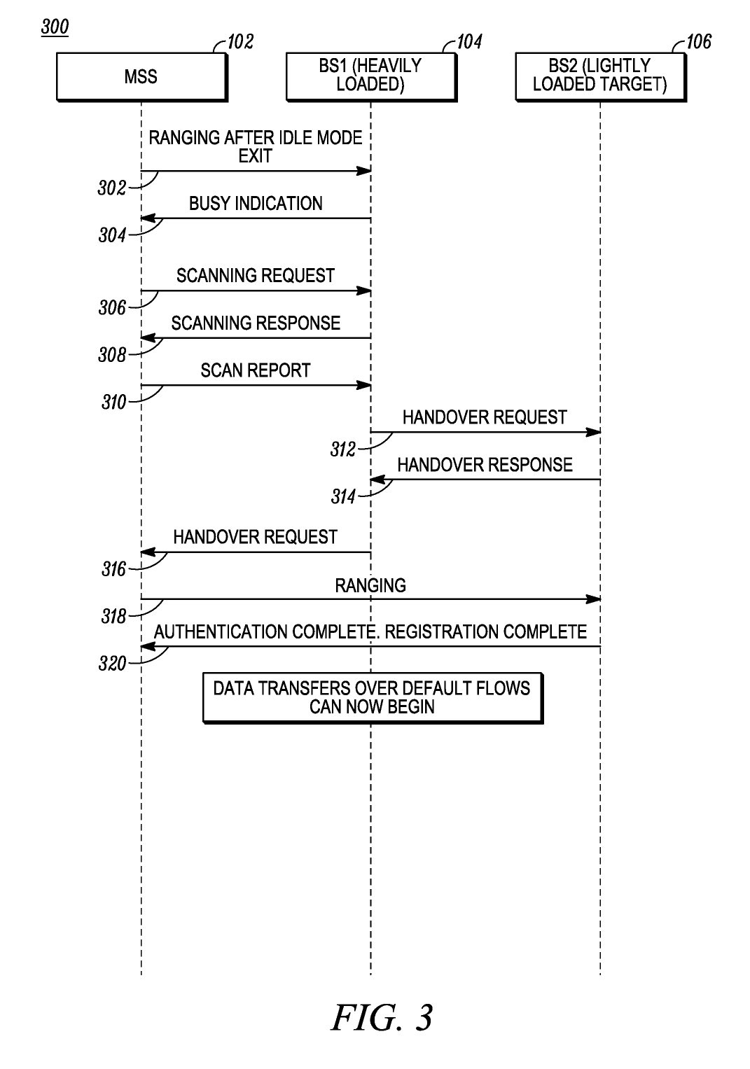

FIG. 3 shows a call flow diagram 300 that permits seamless transfer of a mobile station 102 from an initial base station 104 that is in overloaded or full capacity condition to a neighboring base station 106 during network entry from when the mobile station is in idle mode. When exiting idle mode, the mobile station initiates ranging by sending 302 ranging messages to the initial base station 104. Since the mobile station was in idle mode, authentication with the initial base station 104 has been performed. Upon receipt of the ranging request the initial base station 104 determines that it is in overload condition or that it is fully loaded. If the base station rejects the service flow due to the absence of sufficient resource to admit the service flow, such as determining to reject the ranging request from idle mode, the initial base station 104 initiates procedures to move the mobile station to a different base station such as neighboring base station 106. Accordingly and since the initial base station 104 is in overload condition, it responds 304 to the mobile station with a busy indication that informs the mobile station 102 of the base station's condition and that the base station cannot register the mobile station. Based on the busy indication message, the mobile station knows that the registration with initial base station 104 from idle mode has failed and sends 306 the initial base station 103 a scanning request message. The scanning request message requests that the initial base station provide information regarding the neighboring base stations with which the mobile station can connect to since the initial base station is overloaded. A scan response is sent 308 by the initial base station with this data.

Based on the scan report, the mobile station selects a neighboring base station 106 from among the available base stations provided in the scan report and sends 310 a scan report choosing the neighboring base station 106 to the initial base station 104. With the information regarding the neighboring base station 106, the initial base station 104 sends 312 an handover request to neighboring base station 106, which responds 314 to the initial base station 104 with a handover response. The initial base station 104 then sends 316 data to the mobile station in a handover request message. The mobile station uses the data regarding the neighboring base station 106 to send 318 ranging information to the neighboring base station. The neighboring base station responds 320 with authentication and registration data. Data transfers between the mobile station 102 and the neighboring base station 106 can begin.

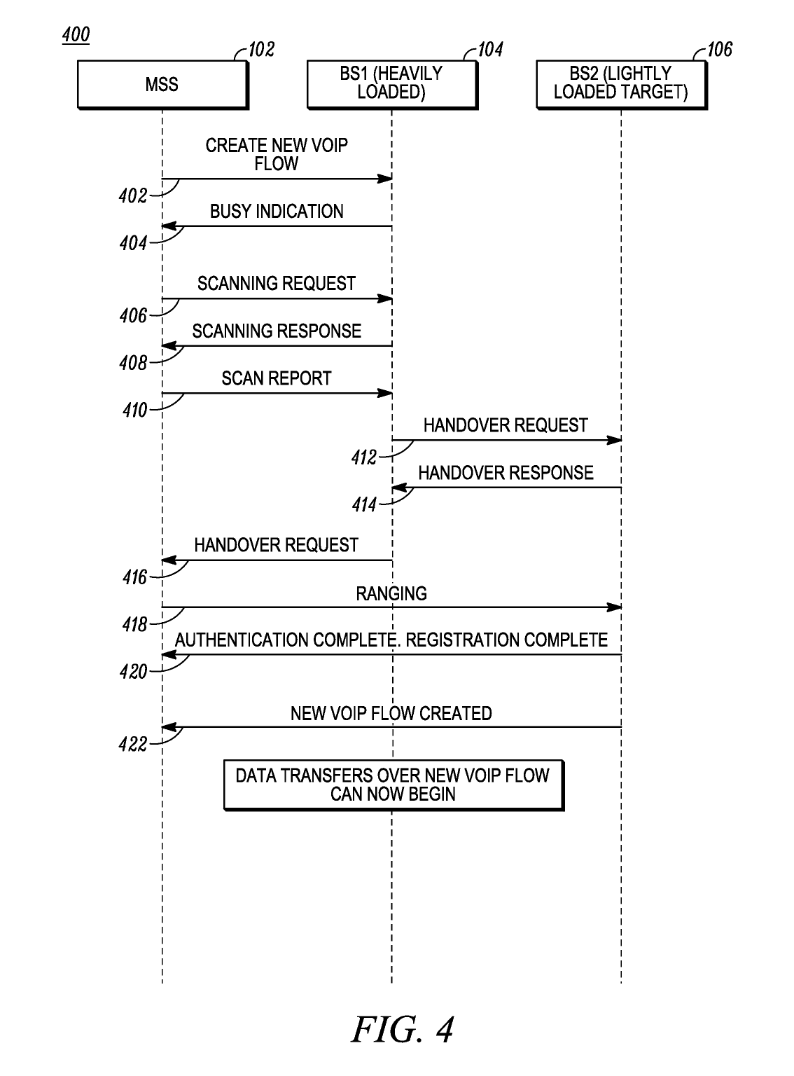

FIG. 4 shows a call flow diagram 300 that permits seamless transfer of a mobile station 102 from an initial base station 104 that is in overloaded or full capacity condition to a neighboring base station 106 when the mobile station begins a new call flow creation such as a VoIP flow request. When creating a new flow request, the mobile station initiates ranging by sending 402 ranging messages to the initial base station 104. Upon receipt of the ranging request the initial base station 104 determines that it is in overload condition or that it is fully loaded. If the base station rejects the service flow due to the absence of sufficient resource to admit the service flow, such as determining that to reject the new flow request, the initial base station 104 initiates procedures to move the mobile station to a different base station such as neighboring base station 106. Accordingly and since the initial base station 104 is in overload condition, it responds 404 to the mobile station with a busy indication that informs the mobile station 102 of the base station's condition and that the base station cannot initiate the call flow with the mobile station. Based on the busy indication message, the mobile station knows that the call flow creation with initial base station 104 has failed and sends 406 the initial base station 103 a scanning request message. The scanning request message requests that the initial base station provide information regarding the neighboring base stations with which the mobile station can connect to since the initial base station is overloaded. A scan response is sent 408 by the initial base station with this data.

Based on the scan report, the mobile station selects a neighboring base station 106 from among the available base stations provided in the scan report and sends 410 a scan report choosing the neighboring base station 106 to the initial base station 104. With the information regarding the neighboring base station 106, the initial base station 104 sends 412 an handover request to neighboring base station 106, which responds 414 to the initial base station 104 with a handover response. The initial base station 104 then sends 416 data to the mobile station in a handover request message. The mobile station uses the data regarding the neighboring base station 106 to send 418 ranging information to the neighboring base station. The neighboring base station responds 420 with authentication and registration data. A new data flow is then created 422. Data transfers between the mobile station 102 and the neighboring base station 106 can begin.

According to the description given above, the mobile station is able to easily and efficiently switch from an overloaded base station to a neighboring base station. This is achieved by the initial base station sending the mobile station a busy indication when it is determined that the initial base station is in the overloaded condition or is at full capacity. The receipt of the busy indication triggers the mobile station to initiate a handover from the overloaded base station to a neighboring base station. With the receipt of the busy indication, the mobile station can forego the 10 to 15 seconds necessary for the mobile station to initiate communication with a neighboring base station after failing to initiate a session with the initial base station. This process provides for rapid channel grant to a neighboring base station in overload conditions. Thus, the initial base station sending the busy indication permits a transfer of context to another base station when a base station is fully loaded, e.g. in a congested network.

The busy indication transfers the initiative of moving from an overloaded base station to a neighboring base station from the mobile station to the base station. In other words, the overloaded base station informs the mobile station that a handover to a neighboring base station is appropriate instead of the mobile station starting a ranging and scanning procedure with a new base station when a session cannot be established with the base station.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
receiving a request from a mobile station to initiate a call session with a base station;
determining that the base station cannot process the call session with the mobile station;
sending a busy indication to the mobile station in response to determining the base station cannot process the call session, and
receiving a scanning request from the mobile station.

2. The method of claim 1 wherein the request is one of a request for network entry, a request for new flow creation and a ranging request after an idle mode exit.

3. The method of claim 1 wherein determining the base station cannot process the call session determines that the base station is fully loaded.

4. The method of claim 1 further comprising sending a scan response to the mobile station indicating a load for a neighboring base station to the base station.

5. The method of claim 4 further comprising handing over the mobile station to the neighboring base station.

6. A method comprising:
sending a request from a mobile station to initiate a call session with a base station;
receiving a busy indication from the base station indicating that the base station cannot participate in the call session, and
sending scan request in response to the busy indication requesting that the base station provide data regarding neighboring base stations.

7. The method of claim 6 wherein the request to initiate a call session is one of a request for network entry, a request for new flow creation and a ranging request after an idle mode exit.

8. The method of claim 6 wherein the busy indication indicates that the base station is fully loaded.

9. The method of claim 6 further comprising receiving a scan response regarding the load on the neighboring base stations.

10. The method of claim 9 further comprising sending a handover request requesting a handover to one of the neighboring base stations.

11. A wireless communication system comprising:
a mobile station, and
a base station wherein the base station receives a request from the mobile station to initiate a call session with the base station, the base station determines that the base station cannot process the call session and sends the mobile station a busy indication.

12. The wireless communication system of claim 1 wherein the request to initiate a call session is one of a request for network entry, a request for new flow creation and a ranging request after an idle mode exit.

13. The wireless communication system of claim 1 wherein the busy indication indicates that the base station is fully loaded.

14. The wireless communication system of claim 1 wherein the mobile station responds to the busy indication by sending a scan request to the base station.
